(19) United States
(12) Patent Application Publication
(10) Pub. No.: US 2026/0055643 A1
(43) Pub. Date: Feb. 26, 2026

(54) VEHICLE DOOR LATCH EQUIPMENT AND ASSOCIATED VEHICLE DOOR

(71) Applicant: Minebea AccessSolutions France, Alfortville (FR)

(72) Inventors: Jean-Marc VERBRUGGHE, Alfortville (FR); François DEBROUCKE, Alfortville (FR); Corentin BOUTOILLE, Alfortville (FR)

(73) Assignee: Minebea AccessSolutions France, Alfortville (FR)

(21) Appl. No.: 19/305,982

(22) Filed: Aug. 21, 2025

(30) Foreign Application Priority Data
Aug. 22, 2024 (EP) 24315386
Aug. 22, 2024 (EP) 24315387

(51) Int. Cl. E05B 81/14; E05B 81/06; E05B 81/30; E05B 81/34

(52) U.S. Cl. CPC E05B 81/14; E05B 81/06; E05B 81/30; E05B 81/34

(57) ABSTRACT

Vehicle door latch equipment includes an engagement mechanism to engage with a striker, a rotatable opening lever to rotate between a rest position and an actuation position wherein the rotatable opening lever releases the engagement mechanism, and an electrical release mechanism including an electrical release motor with an output shaft, a worm arranged on the output shaft, and a gear wheel to mesh with the worm to be rotated between a rest position and an opening position. The equipment also includes a mechanical release mechanism including a rotatable mechanical lever to be linked mechanically to a handle to be rotated between a rest position and an opening position. The rotatable opening lever, the gear wheel, and the rotatable mechanical lever are arranged on a common shaft.

### TECHNICAL FIELD

The present invention relates to the field of vehicle door latches to ensure the closing of vehicle doors and in particular to the latches combining an electrical release mechanism and a mechanical release mechanism.

### BACKGROUND OF THE INVENTION

Nowadays, vehicles are equipped with vehicle door latch equipments comprising an electrical release mechanism, also called E-release mechanism which enables to open the door by a simple move such as a pressure on a button or a movement in front of a detector.

Electrical release mechanisms are more and more developed on the current vehicles as they provide an additional comfort for the user.

However, the existing mechanical release mechanisms are usually kept in addition to the E-release mechanisms as an alternative or as a back-up of the E-release mechanisms.

As a consequence, both mechanisms have to be combined but the available space for both release mechanisms is limited.

It is therefore a goal of the present invention to provide a vehicle door latch equipment comprising both an electrical release mechanism and a mechanical release mechanism with a compact size.

### SUMMARY OF THE INVENTION

The present invention refers to a vehicle door latch equipment comprising:
an engagement mechanism configured for engaging with a striker,
a rotatable opening lever configured to rotate between a rest position and an actuation position wherein the rotatable opening lever releases the engagement mechanism,
an electrical release mechanism comprising an electrical release motor with an output shaft, a worm arranged on the output shaft of the electrical release motor and a gear wheel configured to mesh with the worm to be rotated between a rest position and an opening position, the rotatable opening lever being displaced by the gear wheel so that the rotatable opening lever is in the actuation position when the gear wheel is rotated in the opening position,
a mechanical release mechanism comprising a rotatable mechanical lever configured to be linked mechanically to a handle to be rotated between a rest position and an opening position, the rotatable opening lever being displaced by the rotatable mechanical lever so that the rotatable opening lever is in the actuation position when the rotatable mechanical lever is rotated in the opening position,

wherein the rotatable opening lever, the gear wheel and the rotatable mechanical lever are arranged on a common shaft.

The use of a rotatable opening lever, a gear wheel and a rotatable mechanical lever arranged on a common shaft enables to provide a vehicle door latch equipment combining an electrical release mechanism and a mechanical release mechanism within a compact housing. The assembly of the different parts is also eased and the vehicle door latch equipment may also be reconfigured depending on the vehicle manufacturer needs.

According to another aspect of the present invention, the rotatable mechanical lever rotates independently of the gear wheel and conversely.

According to another aspect of the present invention, a spring is arranged between a housing of the vehicle door latch equipment and the rotatable opening lever to bring the rotatable opening lever back in its rest position.

According to another aspect of the present invention, the rotatable mechanical lever is linked to a return spring configured to bring the rotatable mechanical lever back in the rest position.

According to another aspect of the present invention, the vehicle door latch equipment also comprises a locking mechanism comprising an electrical locking motor with an output shaft, a worm arranged on the output shaft of the electrical locking motor, a locking gear wheel configured to mesh with the worm to be rotated between an unlock position and a lock position and a locking lever configured to be displaced by the locking gear wheel between a first position associated with the lock position of the locking gear wheel wherein the locking lever prevents the release of the engagement mechanism and a second position associated with the unlock position of the locking gear wheel wherein the engagement mechanism can be released.

According to another aspect of the present invention, a spring is arranged between the locking gear wheel and the rotatable opening lever to bring the rotatable opening lever back in its rest position.

According to another aspect of the present invention, in the first position of the locking lever, the locking lever prevents the release of the engagement mechanism only for a mechanical opening from an outer handle.

According to another aspect of the present invention, the rotatable mechanical lever is configured to displace the locking lever in the second position when the rotatable mechanical lever is rotated in the opening position.

According to another aspect of the present invention, the vehicle door latch equipment is reconfigurable so that parts of the mechanical release mechanism such as the rotatable mechanical lever, or parts of the electrical release mechanism such as the electrical release motor and the gear wheel, can be removed without affecting the functioning of the remaining mechanism.

According to another aspect of the present invention, the gear wheel of the electrical release mechanism has a general shape of a portion of a disc and the electrical release mechanism comprises a stop having a general shape of a portion of a disc and wherein the gear wheel is configured to come into contact with a first side of the stop in the rest position and with a second side of the stop in the opening position.

The present invention also refers to a vehicle door comprising a vehicle door latch equipment as described previously and a handle configured to be linked mechanically to the rotatable mechanical lever.

According to another aspect of the present invention, the handle is linked by a rod or a Bowden cable to the rotatable mechanical lever.

According to another aspect of the present invention, the handle is an inner handle.

According to another aspect of the present invention, the vehicle door latch equipment can have a child lock. This prevents a child from accidentally opening a door while the vehicle is moving. For this purpose, the child lock has a mechanical interface that is accessible when the door is open. To activate or deactivate the child lock, a user must activate or deactivate the mechanical interface by turning or pressing the mechanical interface. Behind the mechanical interface is a switch or a sensor that transmits the information to the electronics of the vehicle door latch.

To provide the user with feedback, a visual interface is provided that displays the locking status. For example, an LED can provide information about the locking status. So that a red light means that the child lock is not activated and a green light means that the child lock is activated.

The function is integrated into the electrical module of the vehicle door latch.

### BRIEF DESCRIPTION OF THE DRAWINGS

FIG. 1 is a perspective view of a vehicle door latch equipment according to an embodiment of the present invention;

FIG. 2 is a first perspective view of inner parts of a vehicle door latch equipment according to an embodiment of the present invention;

FIG. 3 is an exploded view of the mechanical release mechanism and the electrical release mechanism;

FIG. 4 is an assembled view of the mechanical release mechanism and the electrical release mechanism;

FIG. 5 is a second perspective view of inner parts of a vehicle door latch equipment according to an embodiment of the present invention;

FIG. 6 is an exploded view of inner parts of a vehicle door latch equipment with two alternative configurations according to two embodiments of the present invention;

FIG. 7 is a third perspective view of inner parts of a vehicle door latch equipment according to an embodiment of the present invention.

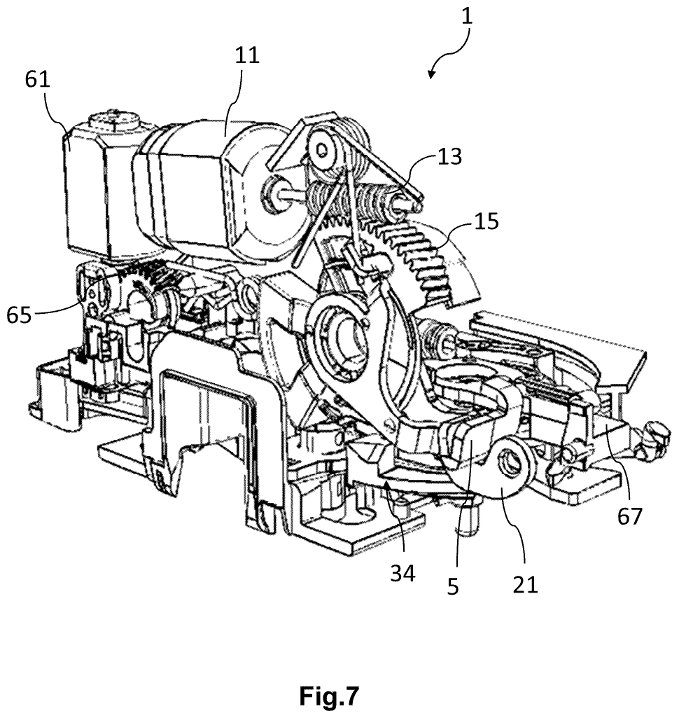

### DETAILED DESCRIPTION OF THE INVENTION

The following achievements are examples. Although, the specification refers to one or several embodiments, it does not imply that each reference refers to the same embodiment or that the features apply only to a single embodiment. Simple features of different embodiments can also be combined to provide other embodiments.

The present invention refers to a vehicle door latch equipment 1 configured to ensure the closing of a vehicle door, in particular a side door or a trunk lid.

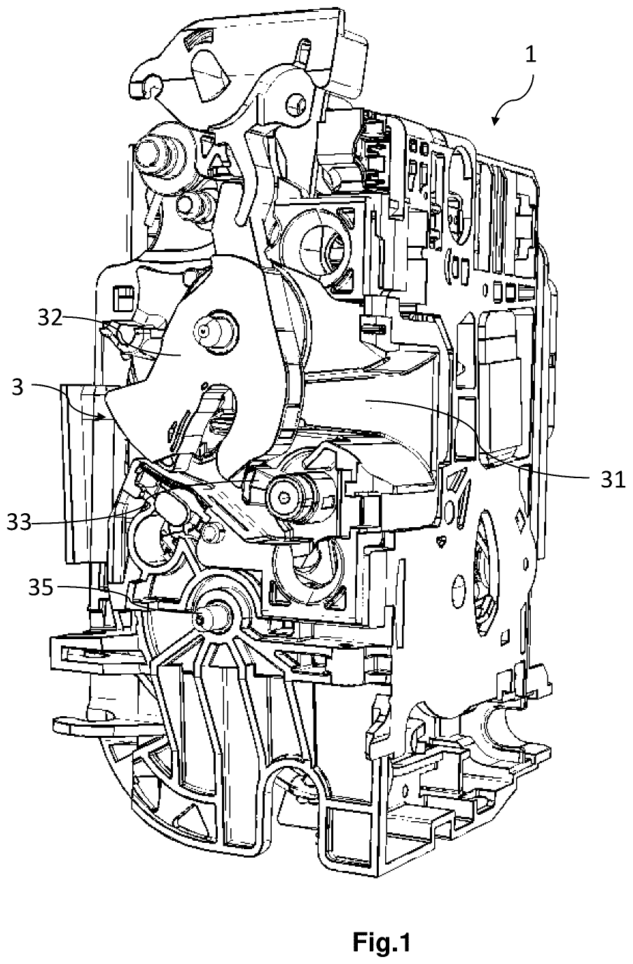

FIG. 1 represents an example of such vehicle door latch equipment 1.

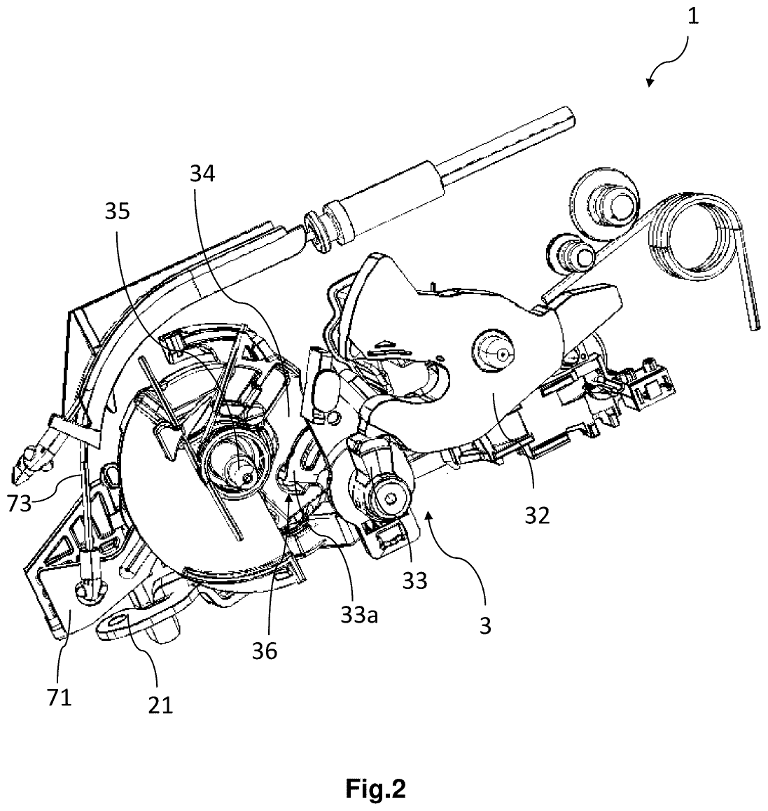

The vehicle door latch equipment 1 comprises an engagement mechanism 3 configured for engaging with a striker (not represented). The striker is arranged on the vehicle body next to the vehicle door and is configured to be introduced into a recess 31 of the vehicle door latch equipment 1 when the vehicle door is closed. The engagement mechanism 3 comprises a claw 32 arranged at least partially in the recess 31 and configured to move between a closed position (as represented in FIG. 1) wherein the striker is retained within the recess 31 by the claw 32 and an opened position wherein the striker may be disengaged from the vehicle door latch equipment 1. The engagement mechanism 3 also comprises a pawl 33 configured to rotate between a blocking position (represented in FIG. 1) wherein the pawl 33 blocks the rotation of the claw 32 so that the striker is retain by the claw 32 and a release position wherein the pawl 33 enables the rotation of the claw 32 and therefore the release of the striker to open the door. As represented in FIG. 2, the engagement mechanism 3 also comprises a driver 34 configured to rotate around a first shaft 35 and to engage with the pawl 33 to rotate the pawl 33 between its blocking position and its release position. The driver 34 may comprises a notch 36 configured to receive a lever 33a of the pawl 33.

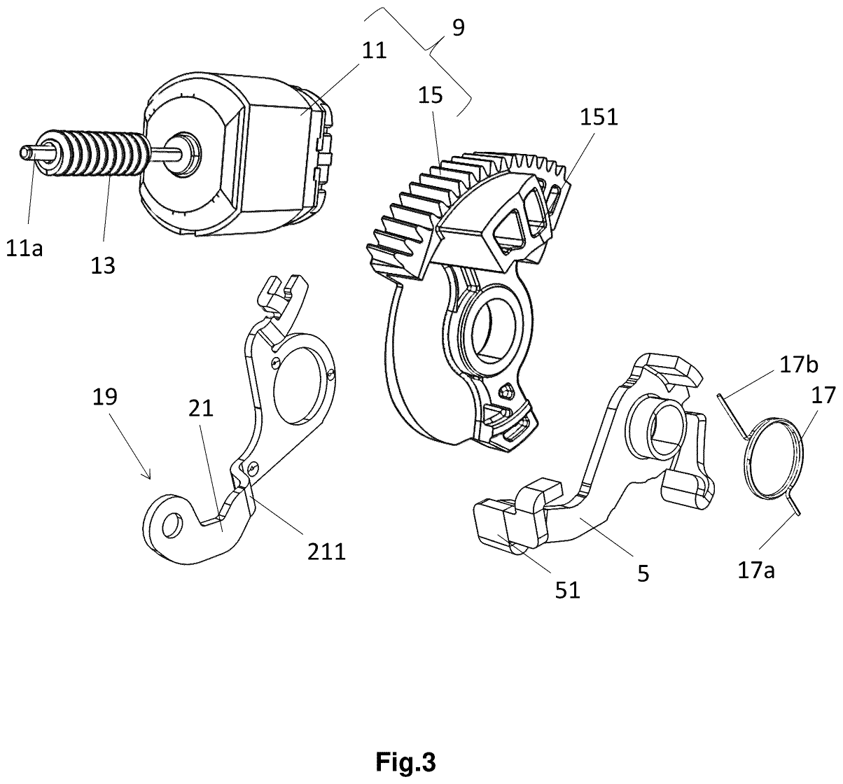

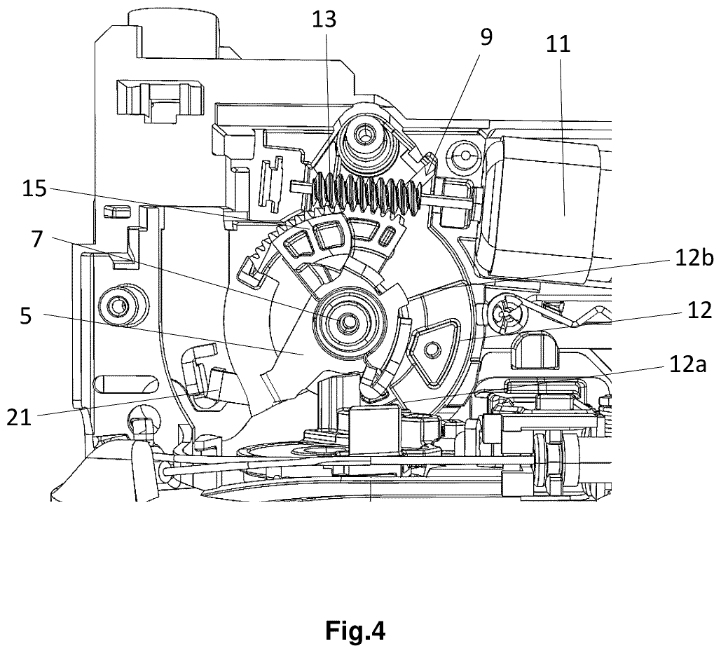

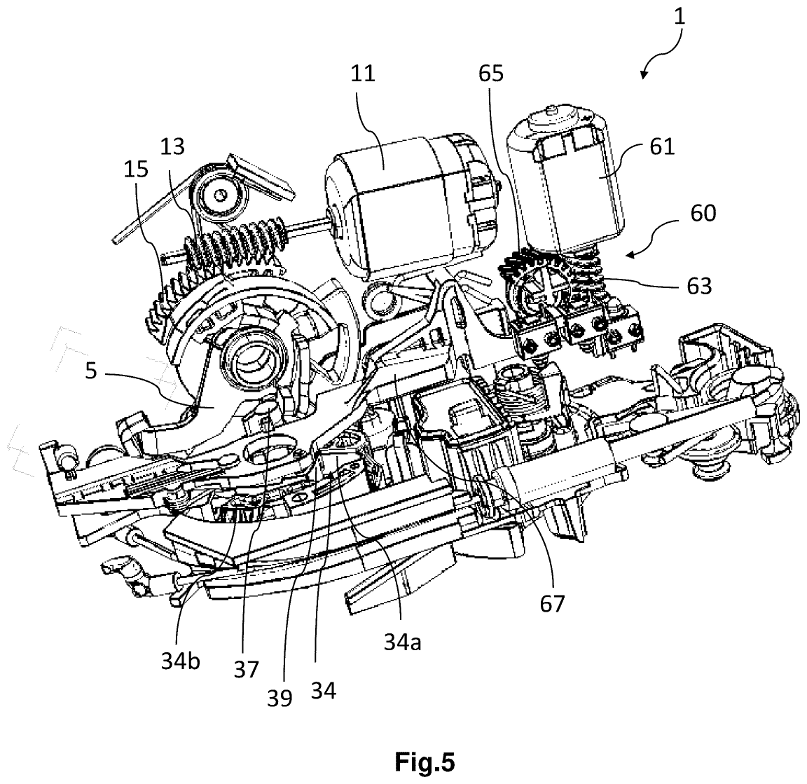

As represented in FIGS. 3 and 4, the vehicle door latch equipment 1 also comprises a rotatable opening lever 5 configured to rotate around a second shaft 7 between a rest position and an actuation position. By rotating from the rest position to the actuation position, the rotatable opening lever 5 is configured to make the driver 34 rotates to release the engagement mechanism 3. The rotatable opening lever 5 is for example configured to push a protruding element 37 of the driver 34 as represented in FIG. 5.

The vehicle door latch equipment 1 also comprises an electrical release mechanism 9. The electrical release mechanism 9 comprises an electrical release motor 11 with an output shaft 11a. According to an embodiment of the invention, the electrical release motor 11 is a reversible motor (the output shaft 11a of the electrical release motor 11 can be rotated in a clockwise or a counterclockwise direction). A worm 13 is arranged on the output shaft 11a of the electrical release motor 11.

The electrical release mechanism 9 also comprises a gear wheel 15 configured to mesh with the worm 15 of the output shaft 13 to be rotated between a rest position and an opening position by the electrical release motor 11. The gear wheel 15 is arranged around the second shaft 7 and is therefore coaxial with the rotatable opening lever 5. Furthermore, the gear wheel 15 may comprise an axial protrusion 151 configured to come in contact with the rotatable opening lever 5. Alternatively or in combination, the rotatable opening lever 5 may comprise an axial protrusion configured to come in contact with the gear wheel 15. The rotatable opening lever 5 is therefore configured to be displaced by the gear wheel 15 so that the rotatable opening lever 5 is rotated in its actuation position when the gear wheel 15 is rotated in its opening position leading therefore to the release of the engagement mechanism 3. The electrical release motor 11 may be configured to bring the gear wheel back in its rest position after the engagement mechanism is released.

The gear wheel 15 may comprise teeth only on a portion of circle which depends on the angular difference between the rest position and the opening position of the gear wheel 15.

The electrical release mechanism 9 may also comprises a stop 12 having a general shape of a portion of a disc and wherein the gear wheel 15 is configured to come into contact with a first side 12a of the stop 12 in the rest position (represented in FIG. 4) and with a second side 12b of the stop 12 in the opening position. The use of such stop 12 reduces the number of parts and eases the assembly of the vehicle door latch equipment 1.

An elastic part, such as a spring 17 may also be arranged around the shaft 7 to bring the rotatable opening lever 5 back in its rest position and in order to reduce the noise and the vibrations. The spring 17 may comprise a first end 17a configured for example to come in contact with the rotatable opening lever 5 and a second end 17b configured to come in contact with the gear wheel 15.

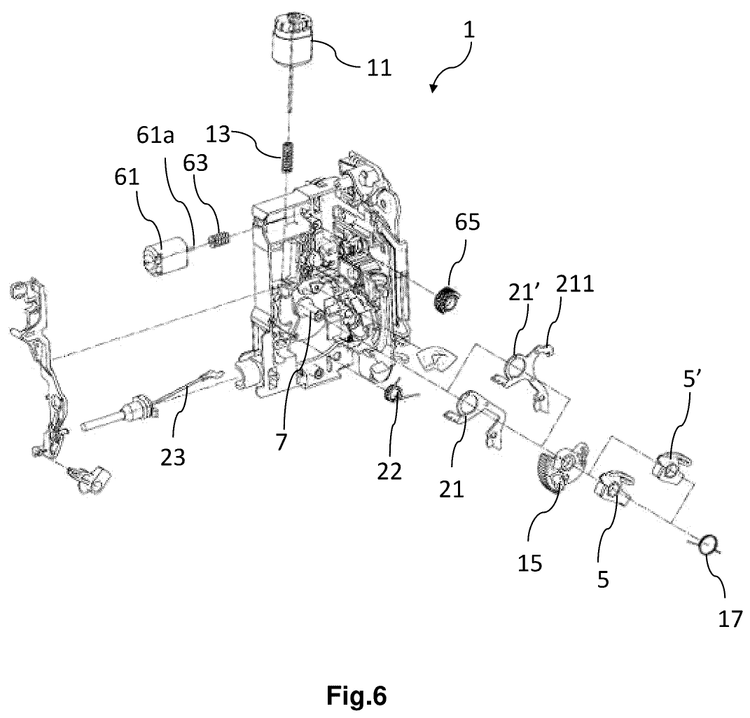

The vehicle door latch equipment 1 also comprises a mechanical release mechanism 19. The mechanical release mechanism 19 comprises a rotatable mechanical lever 21 configured to be linked mechanically to a handle, for example to an inner handle of the vehicle. The rotatable mechanical lever 21 may be linked to the handle by a Bowden cable 23 (visible in FIG. 6) or by a rod. The rotatable mechanical lever 21 is configured to be rotated between a rest position and an opening position. Furthermore, the rotatable mechanical lever 21 may comprise an axial protrusion 211 configured to come in contact with the rotatable opening lever 5. Alternatively or in combination, the rotatable opening lever 5 may comprise an axial protrusion 51 configured to come in contact with the rotatable mechanical lever 21.

A return spring 22 (visible in FIG. 6) may also be arranged between the rotatable mechanical lever 21 and a housing of the vehicle door latch equipment 1 to bring the rotatable mechanical lever 21 back in the rest position when a user releases the handle linked to the rotatable mechanical lever 21.

Thus, the rotation of the rotatable mechanical lever 21 from its rest position towards its opening position leads to the rotation of the rotatable opening lever 5 in its actuation position and therefore to the release of the engagement mechanism 3. The rotatable mechanical lever 21 is arranged around the second shaft 7 and is therefore coaxial with the rotatable opening lever 5 and the gear wheel 15. The gear wheel 15 is for example arranged between the rotatable mechanical lever 21 and the rotatable opening lever 5 along the second shaft 7. Such coaxiality of the rotatable mechanical lever 21, the rotatable opening lever 5 and the gear wheel 15 enables an easy assembly of the different parts of the vehicle door latch equipment 1 and provides a vehicle door latch equipment 1 with both an electrical release mechanism 9 and a mechanical mechanism 19 in a limited space.

Furthermore, such implementation provides a modularity of the vehicle door latch equipment 1. Indeed, the parts of the mechanical release mechanism 19 may be removed to reconfigure the vehicle door latch equipment 1 if only an electrical release mechanism 9 is required. Alternatively, the parts of the electrical release mechanism 9 may be removed to reconfigure the vehicle door latch equipment 1 if only a mechanical release mechanism 19 is required. The mechanical release mechanism 19 and the electrical release mechanism 9 function therefore independently (i.e. the rotatable mechanical lever 21 rotates independently of the gear wheel 15 and conversely) so that parts of the mechanical release mechanism 19 or parts of the electrical release mechanism 9 can be removed without affecting the functioning of the remaining mechanism.

According to an embodiment of the present invention, the vehicle door latch equipment 1 comprises a locking mechanism 60 configured to lock the vehicle door to prevent a user to enter the vehicle from the outside. The locking mechanism 60 comprises an electrical locking motor 61 with an output shaft 61a, a worm 63 arranged on the output shaft 61a of the electrical locking motor 61, a locking gear wheel 65 configured to mesh with the worm 63 to be rotated between an unlock position and a lock position and a locking lever 67 configured to be displaced by the locking gear wheel 65 between a first position associated with the lock position of the locking gear wheel 65 wherein the locking lever 67 prevents the release of the engagement mechanism 3 and a second position associated with the unlock position of the locking gear wheel 65 wherein the engagement mechanism 3 can be released.

The vehicle door latch equipment 1 may also comprise an additional mechanical lever 71 configured to be linked to a handle, for example an outer handle. The additional mechanical lever 71 may be linked to the outer handle by a Bowden cable 73 as represented in FIG. 2 or by a rod.

The vehicle door latch equipment 1 may also comprise an override function to unlock the locking mechanism 60 when a mechanical opening is triggered from an inner handle (to prevent a user to be locked outside of the vehicle after a mechanical opening from an inner handle). In the present case, the rotatable mechanical lever 21 is linked to an inner handle. Thus, the override function may be obtained by the use of modified rotatable mechanical lever 21′ (visible in FIG. 6) comprising an additional protuberance 211 configured to displace the locking lever 67 towards its second position when the modified rotatable mechanical lever 21′ is rotated towards its opening position. A modified rotatable opening lever 5′ may also be needed to work with the modified rotatable mechanical lever 21′ as represented in FIG. 6. The displacement of the locking lever 67 towards its second position leads also the locking gear wheel 65 to rotate towards its unlock position. A contactor may be arranged next to the locking lever 67 to detect its displacement towards its second position in order to trigger the rotation of the electrical locking motor 61 to bring the locking gear wheel 65 back to its unlock position.

Moreover, in order to prevent the override function when the outer handle is pulled by a user, the engagement mechanism 3 may comprise a clutch paddle 39 arranged between the locking lever 67 and the driver 34. In this embodiment, the driver 34 is made of a first part 34a comprising the protruding element 37 and a second part 34b. The clutch paddle 39 is configured to be displaced by the locking lever 67 (when the locking lever 67 is displaced from its first to its second position) from a retracted position to an engaged position wherein the clutch paddle 39 is positioned between the first part 34a and the second part 34b of the driver 34. Furthermore, the additional mechanical lever 71 is configured to rotate the second part 34b of the driver 34 when a user pulls on the outer handle.

As a consequence, if the locking lever 67 is in the first position, the clutch paddle 39 is in its retracted position so that the displacement of the additional mechanical lever 71 via the outer handle leads to the rotation of the second part 34b of the driver 34 towards the first part 34a of the driver 34 but the first part 34a of the driver 34 is not rotated so that the pawl 33 remains in its blocking position. The door remains therefore closed. On the contrary, if the locking lever 67 is in the second position, the clutch paddle 39 is in its engaged position so that the displacement of the additional mechanical lever 71 via the outer handle leads to the rotation of the second part 34b which leads to the rotation of the first part 34a via the clutch paddle 39 which is engaged between the second part 34b and the first part 34b of the driver 34. The pawl 33 is then rotated in its released position.

According to another embodiment, the override function may be provided by an additional lever configured to displace the locking lever 67 when the rotatable opening lever 21 is displaced towards its opening position.

The vehicle door latch equipment 1 may also comprise additional springs to constraint the different parts of the vehicle door latch equipment 1 towards a predetermined position.

Thus, the vehicle door latch equipment 1 presented in the different figures provides a compact equipment which is reconfigurable according to the requirements of the vehicle manufacturer to provide a mechanical release mechanism, an electrical release mechanism or a combination of both with different options such as an override function to prevent a user from being locked outside his vehicle when the door is opened from an inner handle.

The vehicle door latch equipment 1 can have a child lock function (not represented). The child lock function prevents a child from accidentally opening a door while the vehicle is moving. For this purpose, the child lock function has a mechanical interface that is accessible when the door is open. To activate or deactivate the child lock, a user must activate or deactivate the mechanical interface by turning or pressing the mechanical interface. Behind the mechanical interface is a switch or a sensor that transmits the information to the electronics of the vehicle door latch equipment 1.

To provide the user with feedback, a visual interface is provided that displays the locking status. For example, a Light Emitted Diode (LED) can provide information about the locking status. For example, a red light may indicate that the child lock function is not activated and a green light may indicate that the child lock function is activated.

The child lock function is integrated into the electrical module of the vehicle door latch equipment 1.

The present invention also refers to a vehicle door comprising a vehicle door latch equipment 1 as described previously and a handle configured to be linked mechanically to the rotatable mechanical lever, for example by a rod or a Bowden cable to the rotatable mechanical lever 21. The handle may be an inner handle. The door may also comprise an outer handle linked mechanically to the vehicle door latch equipment 1, for example by a rod or a Bowden cable to an additional mechanical lever 71.

1-12. (canceled)

13. Vehicle door latch equipment, comprising:
an engagement mechanism configured to engage with a striker;
a rotatable opening lever configured to rotate between a rest position and an actuation position wherein the rotatable opening lever releases the engagement mechanism;
an electrical release mechanism comprising an electrical release motor with an output shaft, a worm arranged on the output shaft of the electrical release motor, and a gear wheel configured to mesh with the worm to be rotated between a rest position and an opening position, the rotatable opening lever being displaced by the gear wheel so that the rotatable opening lever is in the actuation position when the gear wheel is rotated in the opening position; and
a mechanical release mechanism comprising a rotatable mechanical lever configured to be linked mechanically to a handle to be rotated between a rest position and an opening position, the rotatable opening lever being displaced by the rotatable mechanical lever so that the rotatable opening lever is in the actuation position when the rotatable mechanical lever is rotated in the opening position,
wherein the rotatable opening lever, the gear wheel, and the rotatable mechanical lever are arranged on a common shaft.

14. The vehicle door latch equipment in accordance with claim 13, wherein the rotatable mechanical lever rotates independently of the gear wheel.

15. The vehicle door latch equipment in accordance with claim 13, wherein a spring is arranged between a housing of the vehicle door latch equipment and the rotatable opening lever to bring the rotatable opening lever back in the rest position.

16. The vehicle door latch equipment in accordance with claim 13, wherein the rotatable mechanical lever is linked to a return spring configured to bring the rotatable mechanical lever back in the rest position.

17. The vehicle door latch equipment in accordance with claim 13, further comprising a locking mechanism comprising an electrical locking motor with an output shaft, a worm arranged on the output shaft of the electrical locking motor, a locking gear wheel configured to mesh with the worm to be rotated between an unlock position and a lock position, and a locking lever configured to be displaced by the locking gear wheel between a first position associated with the lock position of the locking gear wheel wherein the locking lever prevents the release of the engagement mechanism and a second position associated with the unlock position of the locking gear wheel wherein the engagement mechanism can be released.

18. The vehicle door latch equipment in accordance with claim 17, wherein, in the first position of the locking lever, the locking lever prevents the release of the engagement mechanism only for a mechanical opening from an outer handle.

19. The vehicle door latch equipment in accordance with claim 17, wherein the rotatable mechanical lever is configured to displace the locking lever in the second position when the rotatable mechanical lever is rotated in the opening position.

20. The vehicle door latch equipment in accordance with claim 13, wherein the vehicle door latch equipment is reconfigurable so that parts of the mechanical release mechanism or parts of the electrical release mechanism can be removed without affecting the functioning of the remaining mechanism.

21. The vehicle door latch equipment in accordance with claim 13, wherein the gear wheel of the electrical release mechanism has a general shape of a portion of a disc and the electrical release mechanism comprises a stop having a general shape of a portion of a disc, and wherein the gear wheel is configured to come into contact with a first side of the stop in the rest position and with a second side of the stop in the opening position.

22. A vehicle door, comprising:
the vehicle door latch equipment in accordance with claim 13; and
the handle configured to be linked mechanically to the rotatable mechanical lever.

23. The vehicle door in accordance with claim 22, wherein the handle is linked by a rod or a Bowden cable to the rotatable mechanical lever.

24. The vehicle door in accordance with claim 22, wherein the handle is an inner handle.
